(19) United States
(12) Patent Application Publication
(10) Pub. No.: US 2007/0091064 A1
(43) Pub. Date: Apr. 26, 2007

(54) Optical navigation device having a variable depth of field

(76) Inventors: Chiang Sun Cheah, Penang (MY); Ban Kuan Koay, Penang (MY); Li Chong Tai, Penang (MY)

Correspondence Address: AVAGO TECHNOLOGIES, LTD., P.O. BOX 1920, DENVER, CO, 80201-1920, US

(21) Appl. No.: 11/254,625

(22) Filed: Oct. 20, 2005

(51) Int. Cl. G09G 5/00

(52) U.S. Cl. 345/156

(57) ABSTRACT

An optical navigation device containing an adjustable depth of field light source is positioned with respect to a surface such that the depth of field of light source can be adjusted to match the Z dimension of a particular surface. In one embodiment, a plurality of individual light sources are used each having a different angle of reflection from the surface. By selecting the light source having an angle of reflection to match the Z dimension of the surface to be navigated the device can be used over a wide range of Z dimensions. In one embodiment, the selection of the proper light source is accomplished upon start-up of the device with respect to a particular surface and in another embodiment a user can adjust the light surface to obtain optimal performance.

### FIELD OF THE INVENTION

This invention relates to optical navigation devices and more particularly to such devices where the depth of field of the optics is variable.

### BACKGROUND OF THE INVENTION

Optical navigation devices are now commonly used, for example with personal computers, for allowing the computer user to “point” to a location on the display screen. An optical navigation device, often called a mouse, projects a light beam onto a surface. The light beam from a mouse moving across the surface reflects from imperfections (artifacts) on the surface. A sensor then picks up the reflections and the direction of travel of the mouse is determined from the surface artifacts as they are being reflected onto the sensor.

This works well when the navigation surface is at a relatively fixed position (Z dimension) with respect to the light beam and the sensor. In existing navigation devices the optical beam has a depth of field (DOF) which is usually about +/−5 mm. Thus, if the navigation surface is positioned more than 5 mm below the surface of the device (as it would be if a 30 mm glass plate were to be positioned between the navigation device bottom and the navigation surface) the reflected light would not impact properly on the sensor due to the Z dimension falling outside the limits of the DOF. In such a situation, and depending upon the exact Z dimension of the navigation surface, directional determinations would either be impossible to make or would be severely affected.

### BRIEF SUMMARY OF THE INVENTION

An optical navigation device containing an adjustable depth of field light source is positioned with respect to a surface such that the depth of field of light source can be adjusted to match the Z dimension of a particular surface. In one embodiment, a plurality of individual light sources are used each having a different angle of reflection from the surface. By selecting the light source having an angle of reflection to match the Z dimension of the surface to be navigated the device can be used over a wide range of Z dimensions. In one embodiment, the selection of the proper light source is accomplished upon start-up of the device with respect to a particular surface and in another embodiment a user can adjust the light surface to obtain optimal performance.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic side view of one embodiment depicting operation of a multiple light source device at the proper Z dimension for one light sources of a multiple light source optical navigation device;

FIG. 2 illustrates a schematic side view of one embodiment depicting operation of the multiple light source of FIG. 1 at the proper Z dimension for a different light source;

FIG. 3 illustrates a schematic side view of an alternate embodiment depicting light with different angles of incidence created by a moving light source;

FIG. 4 illustrates a schematic side view of an alternate embodiment depicting the light from a single light source being split and reflected to create more than one angle of incidence;

FIG. 5 illustrates a schematic side view depicting a refractive element creating multiple angles of incidence of light from a single light source;

FIG. 6 illustrates a schematic side view depicting an implementation of a prior art optical mouse;

FIG. 7 illustrates a simplified schematic side view depicting a prior art optical mouse being operated within the proper Z dimension; and

FIG. 8 illustrates a simplified schematic side view depicting a prior art optical mouse operated with the wrong Z dimension.

### DETAILED DESCRIPTION OF THE INVENTION

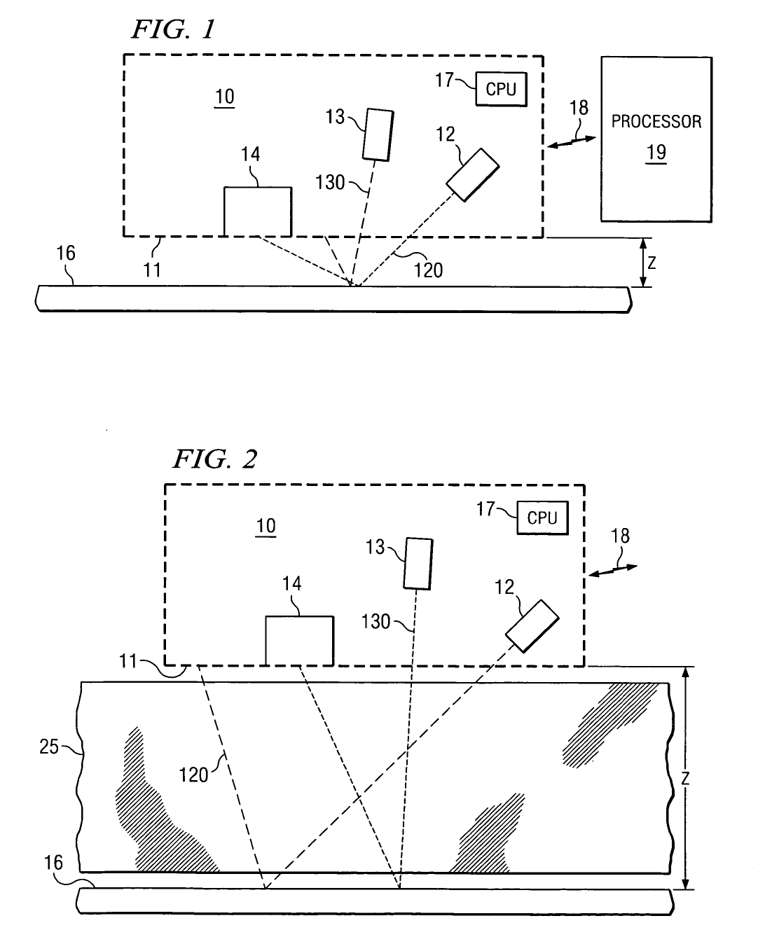

FIG. 1 illustrates a schematic side view of one embodiment depicting operation of a multiple light source navigation device 10 at the proper Z dimension for one light sources of a multiple light source optical navigation device. FIG. 1 shows light sources 12 and 13 having light beams or channels 120 and 130 respectively. Dimension Z is the distance within the depth of field for light column 120 allowing the light to reflect from work surface 16 and impact sensor 14 as shown in solid line 120. Sensor 14 is any well-known sensor that operates to allow for the calculation of navigational movement of navigational device 10 as device 10 moves in horizontal relation to surface 16. In this example, surface 16 is positioned with respect to bottom surface 11 of device 10 such that light reflecting from 16 will impact some (or all) of the pixels of sensor 14. If dimension Z becomes too large (as seen in FIG. 2), surface 16 will move beyond the depth of field of light channel 120 such that the reflected light will miss sensor 14 as shown by dotted line 120.

Continuing in FIG. 1, note that the Z dimension is too “shallow” with respect to the depth of field of light channel 130 from second light source 13 and thus reflected light from surface 16 misses sensor 14, as shown by dashed line 130.

FIG. 2 illustrates a schematic side view of one embodiment depicting operation of the multiple light source of FIG. 1 at the proper Z dimension for a different light source. As discussed above and as shown in FIG. 2, the depth of field (as measured from bottom surface 11 of device 10) is now large enough (in this embodiment, 30 mm) such that the Z distance is within the depth of field for light 13 positioned to allow light reflected from channel 130 to impact sensor 14 as shown in FIG. 2 by dotted line 130. This Z dimension is outside the depth of field for light 12 and thus, as shown by dashed line 120, reflected light from column 120 does not impact sensor 14.

Although depicted with two light sources 12 and 13 yielding two distinct depths of field, additional light sources (not shown) could be added, thereby increasing the number or range of depths of field. For example, by adding a third light a thicker (or a second) transparent medium could be used. If the thicker medium were to be double the size of medium 25 then the Z dimension would be approximately 60 mm. The light channels are advantageously arranged such that the depths of field are adjacent to each other, increasing the overall depth of field and, correspondingly the overall operable range of Z distances in which the device will function properly.

Using multiple light channels allows a transparent medium, such as medium 25, to be inserted between bottom surface 11 of device 10 and actual work surface 16 so long as the Z distance remains within the operable range. The transparent medium need only be transparent to the particular light required by the sensor. If desired, the wavelengths of the different light sources could be different to yield different depths of field perhaps depending upon the intermediary medium.

As depicted in FIGS. 1 and 2, the light from only one light source will impact upon sensor 14 for a given Z distance, thus the selection of a light source for a given Z distance may be accomplished by turning and leaving on both light source 12 and light source 13. Since light from only one light source will impact upon sensor 14, the Z distance will inherently select the proper light source.

Alternatively, selection may also be accomplished by testing each light source. Starting with both light sources 12 and 13 off and then turning on light source 12. If the reflect light from light source 12 impacts upon the sensor then light source 12 is selected to remain on. Otherwise light source 12 will be turned off and light source 13 will be turned on. If the reflected light from light source 13 impacts the sensor then light source 13 will be selected and will remain on. Otherwise the process will be started again with light source 12 until the Z distance of the device is brought to within the depth of focus for light 12 or light 13.

The selection process may also be invoked if the Z distance changes during the operation of the navigation device, such as when a mouse is moved from a mouse pad onto a plate of glass above a navigation surface. When the Z distance changes to a value that is outside of the current depth of focus, reflected light will no longer impact upon the sensor, thus triggering the selection process. Such selection process could be similar to the ones described above or the light sources with depths of field closest to the previous depth of field may be tested before the light sources with depths of field farthest from the current depth of field

One or more buttons (not shown) may be arranged on device 10 such that pressing a particular button may invoke the automated selection process. If desired, the button could allow a user to select an individual light source, or change the selected light source in a predetermined manner, for example, by cycling through all the light sources with successive presses, thereby giving the user of the device control of the depth of field.

Alternatively, the depth of field may be controlled by the system (such as by processor 19 connected by transmission path 18) to which the navigation device is connected. In the example of a personal computer with attached mouse, software on the computer may be used to interactively select the desired depth of field in an automated or user controlled fashion. Alternatively, CPU 17 within device 10 could control the selection of light sources.

When using multiple light channels, the depths of field could partially overlap each other still increasing the overall depth of field but at the same time ensuring a smooth transition when changing light channels.

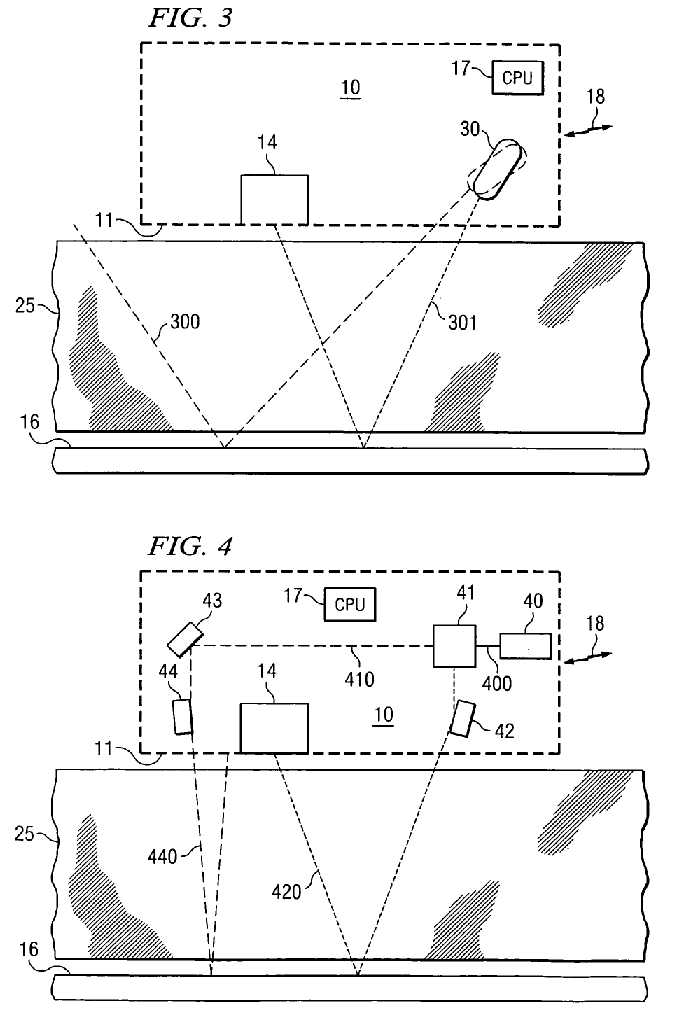

FIG. 3 illustrates a schematic side view of an alternate embodiment depicting light with different angles of incidence created by a moving light source. FIG. 3 depicts variable light channels 300 and 301 created by rotating light source 30 with reflections from light channel 301 on surface 16 impacting sensor 14 and reflections from light channel 300 reflecting from surface 16 missing sensor 14. The multiple channels each with a different depth of field of light source 30 may be created with a rotatable light or with a rotatable mirror or prism in front of a focused light source. The mechanism (not shown) for controlling movement of light source 30 could be controlled by CPU 17 and/or could be controlled from processor 19 via communication path 18.

FIG. 4 illustrates a schematic side view of an alternate embodiment depicting the light from a single light source being split and reflected to create more than one angle of incidence. As is shown in FIG. 4, light from channels 420 and 410 created by light 400 from light source 40 is split by optical splitter 41. Light 420 is reflected by reflector 42 onto surface 17 and then onto sensor 14. Light 410 is reflected by reflectors 43 and 44 and because of its DOF (angle of impact with surface 16) it is reflected away from sensor 14. As depicted, the device is within the depth of field for light column 420 and outside the depth of field for light column 440.

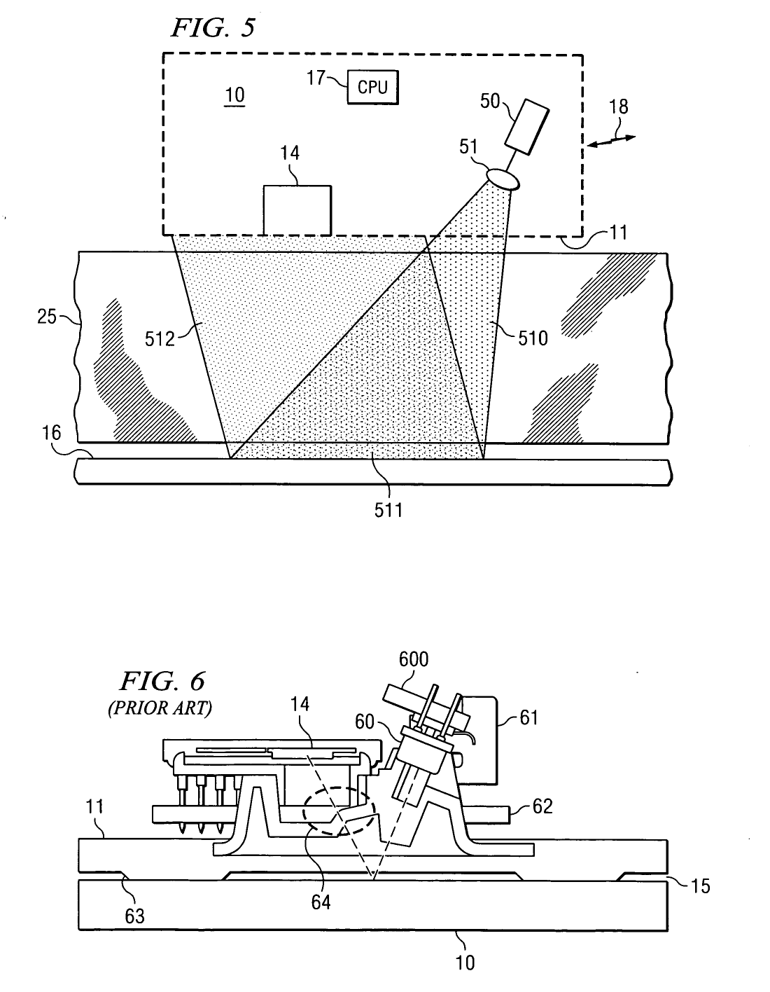

FIG. 5 illustrates a schematic side view depicting a refractive element creating multiple angles of incidence of light from a single light source. As shown light source 50 emits light 500 that passes through cylindrical lens 51 creating planar light sheet 510, which reflects from work surface 16 becoming planar light sheet 512, portions of which impact upon sensor 14. The portion of light sheet 510 and light sheet 512 that are coincident are represented by element 511.

FIG. 6 illustrates a schematic side view depicting an implementation of a prior art optical mouse. FIG. 6 is a side cut away view of a well known optical navigation device implementation. Light source 60 is mounted on printed circuit board (PCB) 600, both of which are held in place relative to sensor 14 via clip 61. Sensor 14 is attached to another PCB 62, which is affixed to the bottom of the device housing. Bottom surface 11 of the device has low friction glides 63 enabling the device to move across work surface 16 and controlling the Z dimension. The bottom of the device has opening 64 through which light may pass out of and in to the device. Light from light source 60 passes out of the device through opening 64, reflects from surface 16 and passes back into the device through opening 64 impacting sensor 14.

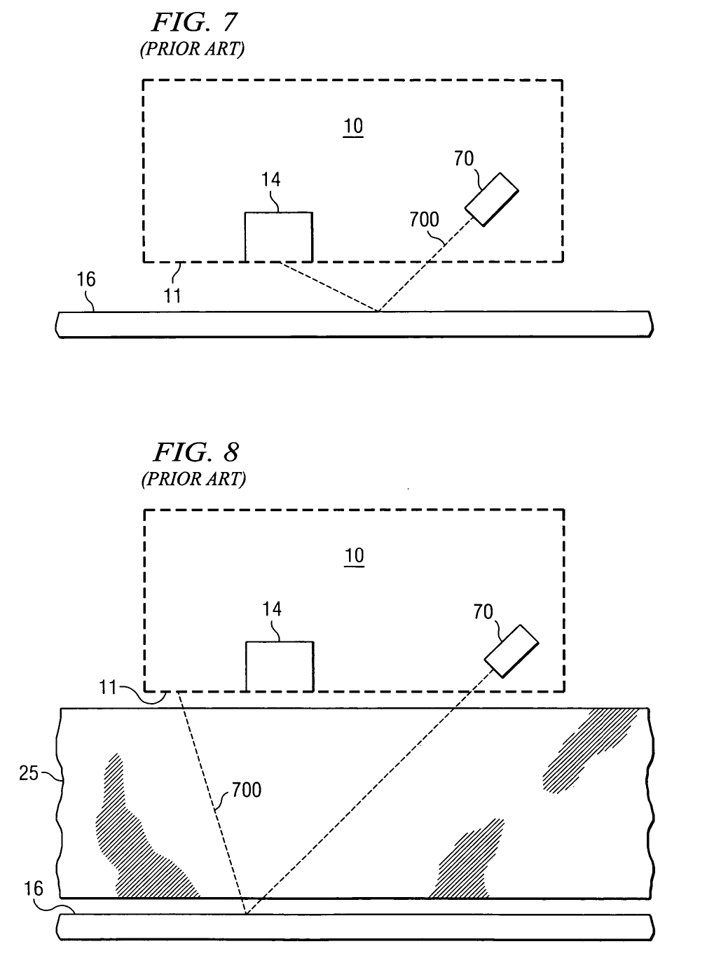

FIG. 7 illustrates a simplified schematic side view depicting a prior art optical mouse being operated within the proper depth of field with light channel 700 from light source 70 reflecting from surface 16 onto sensor 14.

FIG. 8 illustrates a simplified schematic side view depicting a prior art optical mouse operated with the wrong Z dimension. FIG. 8 depicts the device from FIG. 7 being operated outside of the proper depth of field having light channel 700 miss sensor 14.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A navigation device comprising:
at least one light channel for reflecting from a surface, said reflection being used to facilitate a determination of directional movement of said device with respect to said surface, said surface having a Z dimension as measured from a bottom surface of said device; and
means operable when said device is positioned with respect to a particular surface for adjusting the depth of field of at least one light column of said device to match the Z dimension of said particular surface.

2. The device of claim 1 wherein said device comprises multiple light channels each light channel having a different depth of field and wherein said adjusting means comprises:
means for selecting which of said light channels to enable for a particular Z dimension.

3. The device of claim 2 wherein a transparent medium is positioned between said bottom surface of said device and surface, said transparent medium controlling, at least in part, the Z dimension of said surface.

4. The device of claim 2 wherein said depth of field for each of said light columns is a particular fixed Z dimension.

5. The device of claim 4 further comprising:
a sensor for receiving light reflected from said surface for at least one of said light columns; and wherein said adjusting means is controlled, at least in part, by the depth of field of a particular light column as said light column reflects from said surface.

6. The device of claim 2 wherein said depth of field for at least one of said light columns is a variable Z dimension.

7. The device of claim 6 further comprising:
means for allowing a device user to selectively change said variable Z dimension of said variable depth of field light column.

8. The device of claim 2 wherein said light columns are contained within a single housing.

9. A method for determining movement relative to a surface, said method comprising:
positioning a navigation device above said surface, said device containing a plurality of light sources, each light source impacting said surface at a different angle, said angle calculated to yield a depth of field with respect to a base of said navigation device; and
selecting which light source to use for a particular surface, said selection dependant upon the Z dimension between said particular surface and said bottom surface of said navigation device.

10. The method of claim 9 wherein said particular surface is adjacent said navigation device base.

11. The method of claim 9 wherein said particular surface is separated from said navigation base device by a transparent medium.

12. The method of claim 11 wherein said transparent medium has a thickness which yields a Z dimension of approximately 30 mm.

13. The method of claim 9 wherein said Z dimension is variable depending upon the angle of selected light source.

14. The method of claim 9 wherein said selecting comprises:
turning off all said light sources that do not reflect light from said surface to a sensor positioned within said device.

15. The method of claim 9 wherein said selecting comprises:
determining which of said light sources best reflects light from said surface to a sensor positioned within said device.

16. The method of claim 9 wherein said selecting comprises:
manually selecting one of said light sources based on reflection of light from said surface to a sensor positioned within said device.

17. A method for determining movement relative to a surface, said method comprising:
positioning a navigation device above said surface, said device containing a plurality of light sources, each light source having a different depth of field as measured from a base of said navigation device; and
selecting which light source to use for a particular surface, said selection dependant upon the Z dimension between said particular surface and said bottom surface of said navigation device.

18. A method for determining movement relative to a surface, said method comprising:
positioning a navigation device above said surface, said device containing a light source having multiple depth of fields as measured from a base of said navigation device; and
selecting which depth of field to use for a particular surface, said selection dependant upon the Z dimension between said particular surface and said bottom surface of said navigation device.

19. A navigation system for determining movement relative to a surface, said system comprising:
a light source within a housing, said light source having multiple depths of field with respect to said surface, said depth of field being measured from a base of said navigation device; and
an algorithm for determining which depth of field is to be used for any particular surface having a Z dimension as measured from said housing device base.

20. The system of claim 19 wherein said light source is a plurality of light sources each having a unique depth of field.

21. A navigation device for determining movement relative to a surface, said device comprising:
a light source, said light source having multiple depths of field with respect to said surface, said depth of field being measured from a base of said navigation device; and
a sensor positioned to receive light reflected from said surface, said light received based upon the depth of field and the Z dimension of said surface as measured from said base.

22. The device of claim 21 wherein said light source is a plurality of light sources each having a unique depth of field.
